(19) United States
(12) Patent Application Publication
(10) Pub. No.: US 2026/0128951 A1
(43) Pub. Date: May 7, 2026

(54) Satellite Bandwidth Allocation System and Related Methods

(71) Applicant: Hughes Network Systems, LLC, Germantown, MD (US)

(72) Inventors: Fernando SECALI DE OLIVEIRA FILHO, Derwood, MD (US); Yuanlai ZHOU, Germantown, MD (US); Hsui-Chu HUANG, Derwood, MD (US); Xuehong YANG, Rockville, MD (US)

(73) Assignee: Hughes Network Systems, LLC, Germantown, MD (US)

(21) Appl. No.: 18/935,433

(22) Filed: Nov. 2, 2024

(51) Int. Cl. H04L 41/0897; H04B 7/185; H04L 47/24

(52) U.S. Cl. CPC H04L 41/0897; H04B 7/18513; H04L 47/24

(57) ABSTRACT

A system and method for efficiently distributing available bandwidth of a satellite beam among network service providers (NSPs) and virtual network operators (VNOs) associated with the NSPs. The method involves defining bandwidth allocations for each NSP and VNO, receiving demands, dividing the available bandwidth among NSPs and sub-dividing it among VNOs based on respective demands, Minimum Information Rates (MIN), Committed Information Rates (CIR), and Maximum Information Rates (MAX). The method supports multiple traffic priorities, prevents bandwidth starvation, and rebalances bandwidth allocation using a throttle factor during heavy traffic. By sorting demands in ascending order and smoothing beam utilization, the method ensures fairness and efficiency in satellite beam usage.

### FIELD

The present teachings relate to bandwidth allocation methods for managing the distribution of available bandwidth in a satellite network among various network service providers (NSPs) and virtual network operators (VNOs).

### BACKGROUND

In communications, efficient bandwidth allocation is crucial for ensuring optimal network performance and user satisfaction. Bandwidth allocation methods are essential for managing the distribution of available bandwidth among various network service providers (NSPs) and virtual network operators (VNOs). Satellite networks, in particular, face unique challenges in bandwidth allocation due to their inherent limitations in available spectrum and the need to serve a diverse range of users across vast geographical areas. These methods must address the dynamic nature of network traffic, which can vary significantly based on user demand, time of day, and other factors. Traditional bandwidth allocation techniques often struggle to balance the competing needs of different users and services, leading to issues such as network congestion, suboptimal resource utilization, and user dissatisfaction.

The prior art allocates bandwidth across different customers sharing a satellite network under different network conditions. This can lead to bandwidth wastage. In some conventional systems, bandwidth allocation to NSPs/VNOs fails to consider demand, and the specific MIN, CIR and/or MAX values associated therewith. This approach can lead to inefficient use of available bandwidth and may not prevent bandwidth starvation among the NSPs and/or VNOs. Additionally, a lack of support for a flexible number of traffic priorities can limit the ability to efficiently distribute bandwidth among VNOs with different service requirements. Furthermore, existing methods for rebalancing bandwidth among VNOs may not effectively reduce waiting times for other terminals. While some systems attempt to adjust bandwidth allocation based on real-time traffic conditions, the lack of a comprehensive throttle factor calculation incorporating factors such as bandwidth utilization and throughput utilization.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings improve on the prior art. They provide:
Network utilization as an input for bandwidth allocation;
Introduction of CIR as reserved bandwidth and MAX as a best effort assignment;
Throttle factor to keep the waiting time of bandwidth allocation of terminal in a reasonable range, usually on an Inroute;
Flexible number of traffic priorities, for example, to up to 8 priorities;
Multi-level bandwidth distribution;
Multi-directional bandwidth distribution (usable on Inroute and Outroute).

In some aspects, the techniques described herein relate to a computer-implemented method for distributing an available bandwidth of a satellite beam, the method including: defining, for network service providers (NSPs) and one or more virtual network operators (VNOs) associated with one of the NSPs, a bandwidth allocation including a Minimum Information Rate (MIN), a Committed Information Rate (CIR) and a Maximum Information Rate (MAX); receiving a demand for each of the NSPs and each of the one or more VNOs; dividing among the NSPs the available bandwidth by limiting a respective assigned bandwidth for one of the NSPs in turn by a respective demand, a respective MIN, a respective CIR and a respective MAX; sub-dividing among the VNOs the respective assigned bandwidth of an associated NSP by limiting the respective assigned bandwidth of each of the one or more VNOs in turn by a respective demand, a respective MIN, a respective CIR and a respective MAX; and allocating the respective assigned bandwidth for each of the one or more VNOs, wherein the respective MIN, the respective CIR and the respective MAX are distinct for each of the one or more VNOs.

In some aspects, the techniques described herein relate to a method, wherein the available bandwidth is reduced by a beam MAX threshold associated with the satellite beam.

In some aspects, the techniques described herein relate to a method, wherein one of the NSPs is a home NSP and redirecting a leftover bandwidth of the available bandwidth to the home NSP.

In some aspects, the techniques described herein relate to a method, wherein one of the one or more VNOs associated with the home NSP is a non-peak VNO and the sub-dividing redirects a leftover bandwidth of the available bandwidth to the non-peak VNO.

In some aspects, the techniques described herein relate to a method, wherein the dividing of the available bandwidth of the satellite beam is based on weights associated with the NSPs.

In some aspects, the techniques described herein relate to a method, wherein dividing includes satisfying the CIR of NSPs prior to making a best effort to satisfy the MAX of the NSPs if a leftover bandwidth of the satellite beam is greater than a beam threshold after satisfying the CIR.

In some aspects, the techniques described herein relate to a method, wherein the sub-dividing of a leftover bandwidth of one of the NSPs is based on weights of the one or more VNOs associated with the one of the NSPs.

In some aspects, the techniques described herein relate to a method, wherein sub-dividing includes satisfying the CIR of all the VNOs prior to making a best effort to satisfy the MAX of all the VNOs if the respective available bandwidth of the associated NSP is greater than zero after satisfying the CIR.

In some aspects, the techniques described herein relate to a method, wherein the allocating further includes allocating bandwidth to terminals associated with all of the VNOs having a non-zero demand, wherein the bandwidth allocated to the terminals is determined as a minimum of available slots, a service plan rate plus carryover, and a backlog per frame.

In some aspects, the techniques described herein relate to a method, wherein the satellite beam includes an inroute.

In some aspects, the techniques described herein relate to a method, wherein the satellite beam is serviced by a plurality of carrier rate organizers.

In some aspects, the techniques described herein relate to a method, wherein one of the VNOs supports priorities, and the sub-dividing sub-divides the respective assigned bandwidth across the priorities prior to the allocating.

In some aspects, the techniques described herein relate to a method, further including supporting a flexible number of traffic priorities for the sub-dividing.

In some aspects, the techniques described herein relate to a method, further including preventing bandwidth starvation among all the VNOs.

In some aspects, the techniques described herein relate to a method further including sorting in an ascending order, prior to the sub-dividing, the respective demand of the each of the one or more VNOs, wherein the sub-dividing is performed in the sorted order.

In some aspects, the techniques described herein relate to a method, further including rebalancing the assigned bandwidth to all the VNOs using a throttle factor to allocate less bandwidth to terminals during heavy traffic to reduce a waiting time of other terminals, wherein the throttle factor is based on bandwidth utilization and throughput utilization.

In some aspects, the techniques described herein relate to a method, further including smoothing a beam utilization rate of the satellite beam.

In some aspects, the techniques described herein relate to a system to allocate an available bandwidth of a satellite beam, the system including a bandwidth allocator configured to: define, for network service providers (NSPs) and one or more virtual network operators (VNOs) associated with one of the NSPs, a bandwidth allocation including a Minimum Information Rate (MIN), a Committed Information Rate (CIR) and a Maximum Information Rate (MAX); receive a demand for each of the NSPs and each of the one or more VNOs; divide among the NSPs the available bandwidth by limiting a respective assigned bandwidth for one of the NSPs in turn by a respective demand, a respective MIN, a respective CIR and a respective MAX; sub-divide among the VNOs the respective assigned bandwidth of an associated NSP by limiting the respective assigned bandwidth of each of the one or more VNOs in turn by a respective demand, a respective MIN, a respective CIR and a respective MAX; and allocate the respective assigned bandwidth for each of the one or more VNOs, wherein the respective MIN, the respective CIR and the respective MAX are distinct for each of the one or more VNOs.

In some aspects, the techniques described herein relate to a system, wherein the bandwidth allocator sub-divides by satisfying the CIR of all the VNOs prior to making a best effort to satisfy the MAX of all the VNOs if the respective available bandwidth of the associated NSP is greater than zero after satisfying the CIR.

In some aspects, the techniques described herein relate to a system, wherein the bandwidth allocator is further configured to rebalance the assigned bandwidth to all the VNOs using a throttle factor to allocate less bandwidth to terminals during heavy traffic to reduce a waiting time of other terminals, wherein the throttle factor is based on bandwidth utilization and throughput utilization.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1A illustrates a beam hierarchy according to various embodiments.

FIG. 1B illustrates a relationship between some entities of a satellite network according to various embodiments.

FIG. 2 illustrates a method for allocating a beam bandwidth across multiple NSPs and VNOs according to various embodiments.

FIG. 3 illustrates some pseudo code for distributing an available bandwidth of a radio channel in a communication system according to various embodiments.

FIG. 4A illustrates assigned bandwidth for a NSP in a CRO according to various embodiments.

FIG. 4B illustrates EMA allocation of the VNOs and an HNO for the satellite beam according to various embodiments.

FIG. 4C illustrates EMA allocation for a single terminal of each of the VNOs and the HNO for the VNO/HMO distribution of FIG. 4B.

FIG. 4D illustrates CRO EMA utilization according to various embodiments.

FIG. 5A illustrates assigned bandwidth for a NSP in a CRO according to various embodiments.

FIG. 5B illustrates EMA allocation of the VNOs and an HNO for the satellite beam according to various embodiments.

FIG. 5C illustrates EMA allocation for a single terminal of each of the VNOs and the HNO for the VNO/HMO distribution of FIG. 4B.

FIG. 5D illustrates CRO EMA utilization according to various embodiments.

FIG. 6 is a flowchart of a method for distributing an available bandwidth of a satellite beam, according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions are executed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### INTRODUCTION

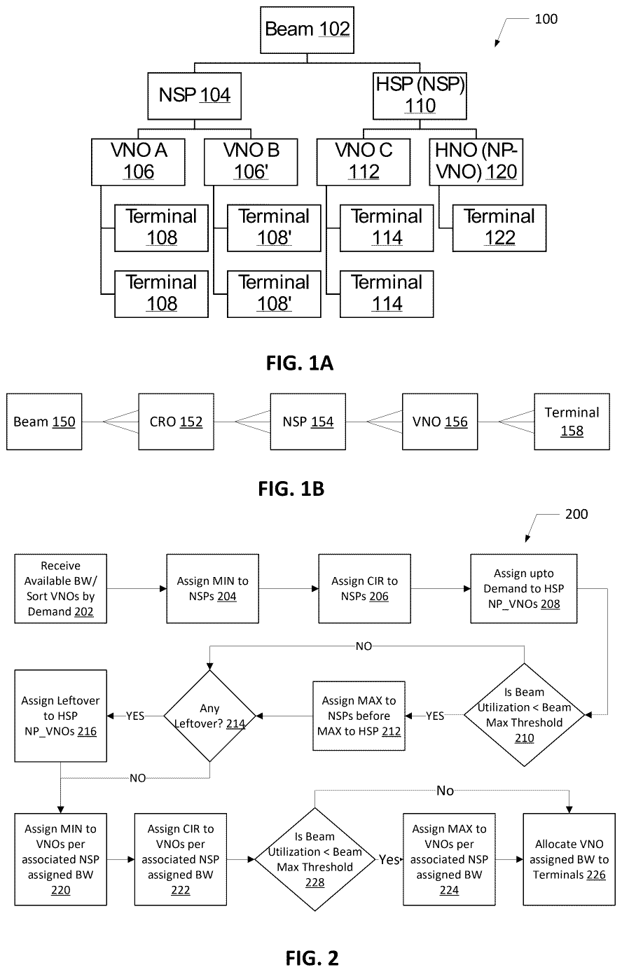

FIG. 1A illustrates a beam hierarchy according to various embodiments.

A satellite network includes multiple beams, for example, beam 102. Bandwidth distribution for beam 102 is done at multiple levels. At the highest level, beam 102 serves a default NSP 110 (referred to as HSP (Home Service Provider) and other NSPs (for example, NSP 104). For terminals 114 served by a VNO 112 and a default VNO 120 (NP-VNO) serving terminals 122. Each of the NSPs (Network Service Providers) may be associated one or more beams.

Each beam, for example, beam 102, has an available bandwidth. Available bandwidth for the beam may be dynamically determined based on many factors, such as, rain fade, satellite location relation to a terrestrial location of the terminal, frequency band, intra-beam interference or the like. The available bandwidth may be determined by a schedular that may be disposed at a satellite network data center or gateway.

NSPs can be dedicated for a customer or for a group of customers. NSPs are typically configured as dedicated for VARs (Value Added Reseller) since they bring their own customers that can be serviced by a VNO (Virtual Network Operator). For example, NSP 104 services VNO A 106 that serves multiple terminals 108 and VNO B 106′ that serves multiple terminals 108′. Smaller enterprise contracts may be configured under a default NSP, for example, HSP 110. HSP 110 may service a VNO C 112 serving terminals 114. HSP 110 may service the default VNO (also known as an HNO (Home Network Operator)). HNO 110 and other VNOs of an NSP may be a defined as a NP-VNO (Non-Peak Virtual Network Operator).

Bandwidth assignment within a beam's available bandwidth applies distinct MIN/CIR/MAX rates at VNO and NSP level, where each level has a separate set of MIN/CIR/MAX. The bandwidth assignment includes a first pass at the NSP level followed by a second pass at the VNO. In the first pass, the NSP bandwidth assignment calculation is based on MIN/CIR/MAX and demand of the NSP, where the associated NSP bandwidth assignment is limited by the available capacity of the beam. In the second pass, the VNO bandwidth assignment calculation is based on MIN/CIR/MAX and demand of VNO, where the associated VNO bandwidth assignment is limited by the NSP assignment.

An outroute is a beam (communications path) from gateway to satellite to terminal. For purposes of the present discussion, an inroute (from terminal to satellite to gateway) may be viewed as a beam for determining the available bandwidth on the inroute even though there may not be a beam per say. Beyond the initial bandwidth assignment, the final respective assignments of the NSPs and VNOs may be limited by CRO, Outroute, and Beam capacity. In some embodiments, the final NSP assignment limit is enforced into a group of VNOs belonging to the NSP. Similarly, the final VNO assignment limit is enforced into a group of terminals that belong to the VNO.

The present teachings distribute available bandwidth of a beam to associated NSPs. The teachings meet a VNO's CIR, transition between VNO's MIN and CIR, transition between VNO's CIR and MAX, include NP-VNOs, redirect leftover bandwidth to an HSP/HNO, prevent starvation, and set a bandwidth allocation timer.

The satellite network endeavors to at least provide the MIN rate for the NSPs of the beam if there is a demand in the system for a terminal that is for a customer of the NSP (for example, at least one (1) packet). CIR is an agreed upon bandwidth for a NSP (usually agreed contractually) and the satellite system endeavors to reserve that amount of bandwidth. MAX bandwidth is only offered to NSPs if the system is being underutilized. After reserving MIN and CIR rate bandwidth to NSPs (NSPs other than the HSP), any leftover available bandwidth is assigned to a HSP (Host Service Provider). The HSP is a unique NSP that also has MIN, CIR and MAX rates. After satisfying CIR rates of the NSPs including the HSP, the NSPs are assigned any bandwidth left, up to their demand.

The NSP or HSP includes one or more VNOs (Virtual Network Operators). A MIN, CIR and MAX rate in Mbps is provided for each VNO and each NSP. A NSP including an HSP may have one or multiple VNOs or NP-VNOs. A NP-VNO has MIN and CIR rates; however, a NP-VNO has no MAX rate. The lack of a MAX rate may be used to assign or capture any unassigned available bandwidth of a beam or the associated NSP. At least one NP-VNO is configured in the HSP, namely a HNO (Host Network Operator). The HNO receives any unused bandwidth up to demand. More than one NP-VNO could be configured under the HSP. As such, each NSP and VNO of a beam is configured with MIN, CIR and MAX rates.

FIG. 1B illustrates a relationship between some entities of a satellite network according to various embodiments.

A beam 150 may be serviced by many CROs 152 (Carrier Rate Organizers). Beam 150 may service one or more NSPs 154 within one of the CROs 152 associated with beam 150. Each of the one or more NSPs 154 may service one or more VNOs 156. Each of the VNOs 156 may service one or more terminals 158.

FIG. 2 illustrates a method for allocating a beam bandwidth across multiple NSPs and VNOs according to various embodiments.

A method 200 for allocating a beam bandwidth across multiple NSPs, which treats MIN, CIR and MAX rates distinctly is disclosed. Speaking broadly, method 200 includes operation 202 to receive available bandwidth in a satellite beam and values for demand by each of the NSPs and VNOs associated with the beam. In some embodiments, the demand of the VNOs may be sorted. Method 200 includes operation 212 to assign MAX rates 212 to the NSPs after operations 204 and 206 for assigning the MIN and CIR rates for each of NSPs. Performance of operation 212 may be predicated on operation 210 to ensure that beam utilization is under a beam MAX threshold. Any leftover bandwidth from the available bandwidth after operation 210 and 212, may be assigned to a NP-VNO of a HSP at operation 216. The dividing of available bandwidth among the NSPS may be considered a first pass for bandwidth distribution.

A second pass for bandwidth distribution, may sub-divide bandwidth to each NSP to the associated VNOs. To satisfy VNO's CIR and MAX, all VNOs' MIN is satisfied from the associated NSPs' bandwidth first at operation 220. An effort is then made to satisfy CIR of all VNOs, from the associated NSPs' bandwidth, having a demand at operation 222. Lastly, an effort is made to satisfy MAX of all VNOs, from the associated NSPs' bandwidth, having a demand at operation 224. Performance of operation 224 may be predicated on operation 228 to ensure that beam utilization is under a beam MAX threshold.

For example, given two VNOs with CIR and MAX configured as (5, 20) Mbps and (10, 30) Mbps, total bandwidth of 20 Mbps, both VNOs have big demand and equal weight, the method 200 may operate as follows. First, CIR is satisfied for the VNOs with a bandwidth assignment of the two VNOs as (5, 10) Mbps. Then the leftover available bandwidth of 5 Mbps is distributed among the VNOs. Since both VNOs have equal weight, they get equal allocation from the leftover bandwidth. So, the final allocation of the two VNOs is (7.5, 12.5) Mbps.

Method 200 may include operation 226, performed after VNOs bandwidth allocation/assignment, where each VNO allocates bandwidth to its associated terminals. In some embodiments, bandwidths allocated to terminals is determined as Allocated bandwidth=min (available slots, service plan rate+carryover, backlog) per frame. When a VNO has many associated terminals and terminals have heavy traffic, all bandwidth of a frame could be allocated to one terminal, which prolongs the waiting time of other terminals. A ‘throttle factor’, as seen below, may be used to allocate less bandwidth to terminals during heavy traffic to keep the waiting time of other terminals in a reasonable range. Allocated bandwidth=min (available slots, throttle factor*(service plan rate+carryover), backlog)

### Calculation of Beam Utilization

The MAX configuration of VNO can be used only if the overall beam utilization is lower than a configured threshold (default value of BeamMaxUtilThresh=85%). The overall beam utilization at time (t) can be considered as the average of the CRO utilization [uCRO(i,t)] across N Outroutes:

$${u}_{( beam , t )} = \frac{{\sum }_{i = 0}^{n} {u}_{CRO ( i , t )}}{n}$$

To calculate inroute beam utilization, denote

$${L}_{j}^{slot} ( t )$$

the total leftover slots in the j-th IGM at time (t) (Unit: slots),

$${U}_{j}^{slot} ( t )$$

the total unused slots in the j-th IGM at time t (slots) and,

$${T}_{j}^{slot} ( t )$$

as the total usable slots in the j-th IGM. The overall beam utilization at time (t) can be defined as:

$${u}_{Beam} ( t ) = 1 - [ \frac{{\sum }_{j = 1}^{J ∈ BEAM} {L}_{j}^{slot} ( t ) + {U}_{j}^{slot} ( t )}{{\sum }_{j = 1}^{J ∈ BEAM} {T}_{j}^{slot} ( t )} ]$$

The considered beam utilization should be smoothed by a configured factor α [default value of 0.2] to avoid burstiness.

$${EMA\_u}_{( beam , t )} = α . {EMA\_u}_{( beam , t )} + ( 1 - α ) . {EMA\_u}_{( beam , t - 1 )}$$

MAX configuration of VNO is expected to be used during off-peak hours or in low-congested networks. Most enterprise customers are expecting to always see their CIR. MAX is more of a best effort assignment and can only be done after all CIR of VNOs are satisfied. If there is any demand below CIR within an NSP that is not satisfied, there should not be any bandwidth left to be used by MAX.

Network or beam congestion in distribution of bandwidth may be accounted for using a throttle factor. In some embodiments, the throttle factor may be calculated as a function of congestion as, for example:

$$throttle factor = ( throughputCapacity + bwAllocCapacity ) / 2$$

$$throughputCapacity = sum throughput of terminals / adjusted capacity$$

$$bwAllocCapacity = sum allocated bandwidth of terminals / adjusted capacity$$

$$For Inroute allocation : adjusted capacity = total capacity of beam - Aloha allocation$$

$$For Outroute allocation : adjusted capacity = total capacity of beam$$

### Dividing Available Bandwidth and Sub-Dividing NSP Assigned BW to Associated VNOs

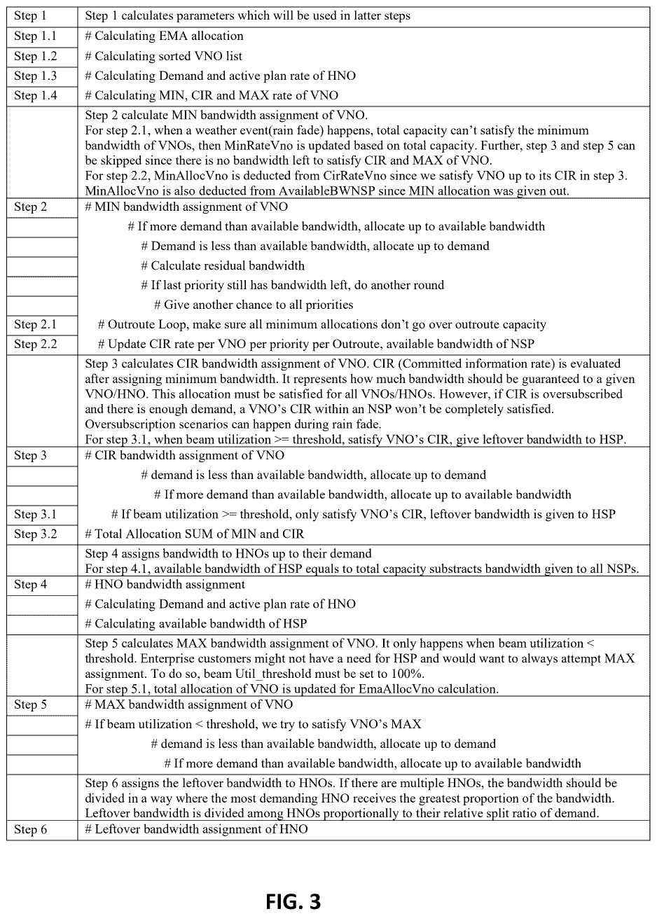

FIG. 3 illustrates some pseudo code for distributing an available bandwidth of a radio channel in a communication system according to various embodiments.

Pseudo code for distributing an available bandwidth of a radio channel in a communication system may be done in passes. For example, the distribution of available BW may be done in a first pass to NSPs (entities) as assigned bandwidths. The assigned bandwidths of the NSPs may be further distributed or sub-divided across VNOs (sub-entities) in a second pass. In some embodiments, BW assigned to VNOs may be further sub-divided by priority prior to being allocated to terminals associated with the VNO. BW assignment to the NSPs and VNOs (and priorities in the VNOs) may be based on one or more of the following parameters (configured and/or calculated per the present teachings):
a) VNO Sorted list in ascending order.
b) Pre-assigned weights for interactive, streaming and bulk and more classes at CRO level for a P number of priorities.
c) Available bandwidth per NSP per priority per Outroute for a N is number of NSPs, P number of priorities, M number of Outroutes.
d) Available bandwidth per priority per Outroute for a P number of priorities and M number of Outroutes,
e) Demand per VNO per Outroute for a N number of VNOs and M number of Outroutes.
f) Demand per HNO per Outroute for N number of HNOs and M number of Outroutes.
g) Minimum rate per VNO per priority per Outroute for N number of VNOs, P number of priorities and M number of Outroutes.
h) CIR per VNO per Outroute for N number of VNOs and M number of Outroutes.
i) Maximum rate per VNO per Outroute for N number of VNOs and M number of Outroutes.
j) Configured minimum rate of VNO for N number of VNOs.
k) Configured CIR of VNO for N number of VNOs.
l) Configured MAX rate of VNO for N number of VNOs.
m) EMA allocation of VNO per VNO per Outroute for N number of VNOs and M number of Outroutes.
n) Total allocation per VNO per Outroute for N number of VNOs and M number of Outroutes.
o) Total bandwidth allocation per VNO per priority per Outroute for N number of VNOs, P number of priorities and M number of Outroutes.
p) Total bandwidth allocation per HNO per priority per Outroute for N number of HNOs, P number of priorities and M number of Outroutes.
q) Minimum bandwidth allocation per VNO per priority per Outroute based on a MIN rate for each VNO.
r) CIR bandwidth allocation per VNO per priority per Outroute based on a CIR rate for each VNO.
s) Maximum bandwidth allocation per VNO per priority per Outroute based on MAX rate for each VNO.
t) Backlog/demand per VNO per priority per Outroute.
u) Backlog/demand per HNO per priority per Outroute.
v) Leftover bandwidth given to HSP per NSP per Outroute.
w) Leftover bandwidth given to HSP per Outroute.
x) Smoothing factor for assigned BW to each VNO.
y) Spectrum efficiency of VNOs.
z) Weight of each VNO based on service subscription.
aa) Beam utilization threshold.

### Simulation Validation: Case 1

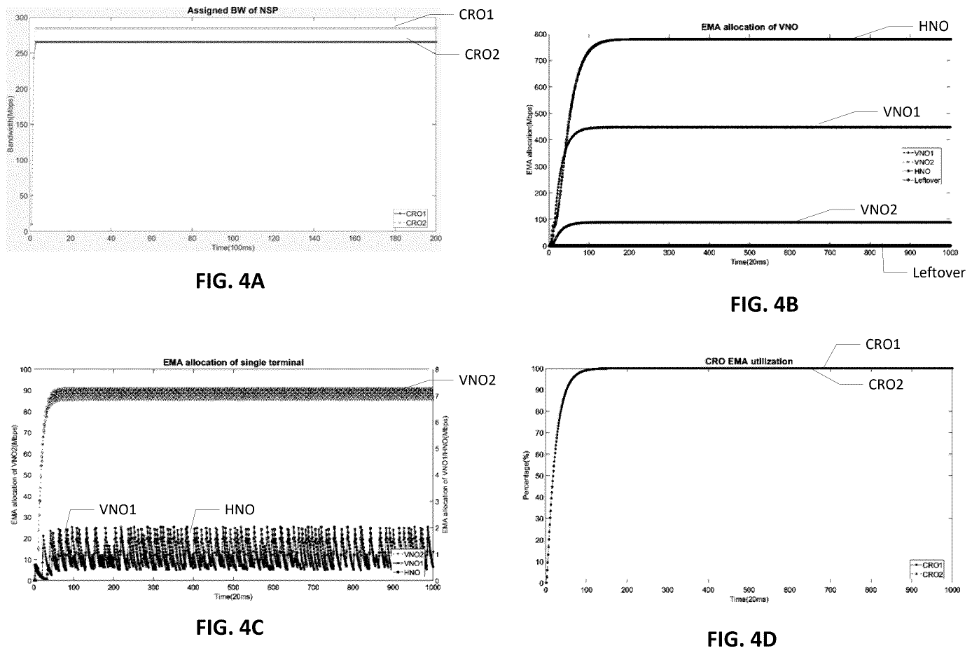

FIG. 4A illustrates assigned bandwidth for a NSP in a CRO according to various embodiments.

FIG. 4B illustrates EMA allocation of the VNOs and an HNO for the satellite beam according to various embodiments.

FIG. 4C illustrates EMA allocation for a single terminal of each of the VNOs and the HNO for the VNO/HMO distribution of FIG. 4B.

FIG. 4D illustrates CRO EMA utilization according to various embodiments.

In the case 1 simulation the following parameter settings were used:
a) Number of CROs: 2
b) Total capacity/available bandwidth: 1316 Mbps
c) CRO priority weight: [0.3, 0.3, 0.4]
d) Number of priorities: 3
e) Number of VNOs: 2
f) Number of HNOs: 1
g) Number of NSP: 1
h) Number of HSP: 1
i) Number of terminals associated with VNO1, VNO2 and HNO: [400, 1, 800]
j) Service plan rate of terminals in VNO1, VNO2 and HNO: [6, 100, 6] Mbps
k) MIN, CIR and max subscription of VNO1: [5, 500, 500] Mbps
l) MIN, CIR and MAX subscription of VNO2: [5, 100, 100] Mbps
m) MIN, CIR and MAX subscription of NSP: [10, 550, 550] Mbps
n) Interactive, streaming and bulk traffic per terminal of VNO1: [2, 2, 2] Mbps
o) Interactive, streaming and bulk traffic per terminal of VNO2: [33, 33, 33] Mbps
p) Interactive, streaming and bulk traffic per terminal of HNO: [2, 2, 2] Mbps

The above example assumes that a CRO's max capacity is 550 Mbps and that the VNOs are allocated bandwidth across all the CROs of a beam. CRO weight is (0.3, 0.3, 0.4), VNO2 weight rate is (30, 30, 40), demand is (33, 33, 33). The highest allocation per frame of VNO2 is 99 Mbps, which means the residual bandwidth from bulk could be given to all priorities.

In FIG. 4A, NSP assignment is 550 Mbps, which equals to its CIR/MAX. Since VNO2 only has one terminal, VNO2 only associates with one of the CROs, for example, CRO2. NSP assignment in CRO1 is around 265 Mbps, which is bigger than MAX rate of VNO1 in CRO1(251). Thus, some bandwidth becomes leftover bandwidth, which is given to HSP (550-447.7−88.3=14 Mbps). NSP assignment in CRO2 is around 285 Mbps, VNO1 and VNO2 need to compete the bandwidth based on the sorted list mechanism. Thus, VNO2 is assigned less than its MAX rate (100 Mbps).

In FIG. 4B, EMA allocation of VNO1, VNO2 and HNO are 447.7 Mbps, 88.3 Mbps, 780 Mbps

Even though CRO load balancing is enabled, NSP assignment in CRO1 and CRO2 are not evenly distributed, which is due to a tolerance configuration of NSP.

### Simulation Validation: Case 2

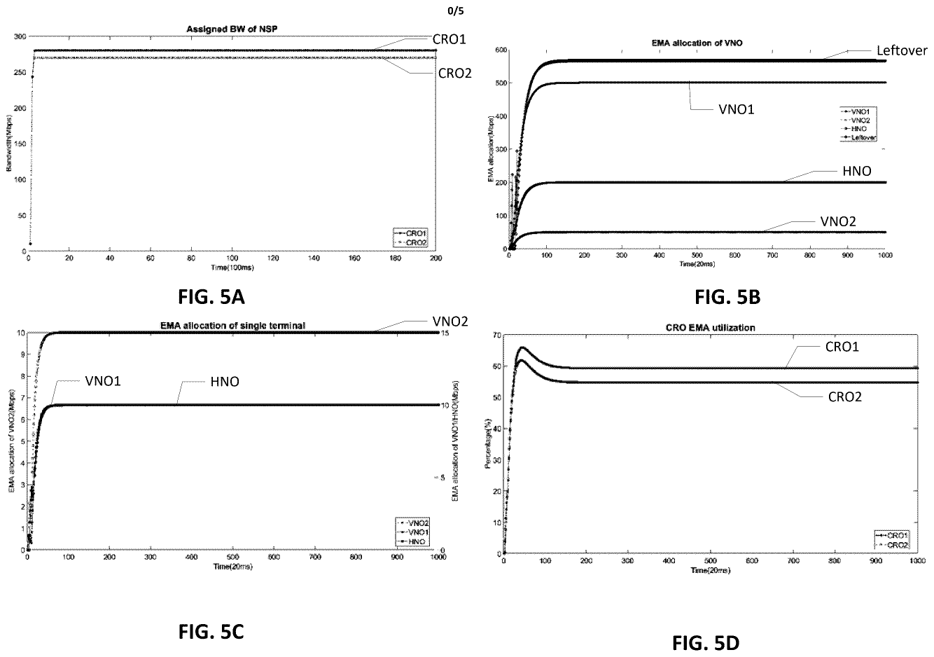

FIG. 5A illustrates assigned bandwidth for a NSP in a CRO according to various embodiments.

FIG. 5B illustrates EMA allocation of the VNOs and an HNO for the satellite beam according to various embodiments.

FIG. 5C illustrates EMA allocation for a single terminal of each of the VNOs and the HNO for the VNO/HMO distribution of FIG. 4B.

FIG. 5D illustrates CRO EMA utilization according to various embodiments.

In the case 1 simulation the following parameter settings were used:
a) Number of CROs: 2
b) Total capacity: 1316 Mbps
c) CRO priority weight: [0.2, 0.2, 0.2, 0.1, 0.3]
d) Number of priorities: 3
e) Number of VNOs: 2
f) Number of HNOs: 1
g) Number of NSP: 1
h) Number of HSP: 1
i) Number of terminals associated with VNO1, VNO2 and HNO: [50, 5, 20]
j) Service plan rate of terminals in VNO1, VNO2 and HNO: 10 Mbps
k) MIN, CIR and MAX subscription of VNO1: [5, 300, 500] Mbps
l) MIN, CIR and MAX subscription of VNO2: [5, 300, 500] Mbps
m) MIN, CIR and MAX subscription of NSP: [10, 550, 550] Mbps
n) 5 priorities' traffic per terminal of VNO1: [2, 2, 2, 2, 2] Mbps
o) 5 priorities' traffic per terminal of VNO2: [2, 2, 2, 2, 2] Mbps
p) 5 priorities' traffic per terminal of HNO: [2, 2, 2, 2, 2] Mbps

In FIG. 5A, NSP assignment is 549.95 Mbps (due to tolerance configuration), EMA allocation of VNO1, VNO2 and HNO are 499.95 Mbps, 50 Mbps, 200 Mbps, leftover BW is 566.05 Mbps. Since beam utilization is smaller than default threshold (85%), VNOs could reach their MAX subscription.

Based on the pseudo code of FIG. 3, the bandwidth distribution may be extended to N priorities by changing a value of number of priorities.

CRO weight is (0.2, 0.2, 0.2, 0.1, 0.3), VNO1 weight rate is (100, 100, 100, 50, 150), demand is (100, 100, 100, 100, 100). The 4th priority of VNO1 only has 50 Mbps reserved bandwidth but 100 Mbps demand, the 5th priority has 150 Mbps reserved bandwidth, but only 100 Mbps demand. The highest allocation per frame of VNO1 is 499.95 Mbps, which means the residual bandwidth from the 5th priority could be given to the 4th priority.

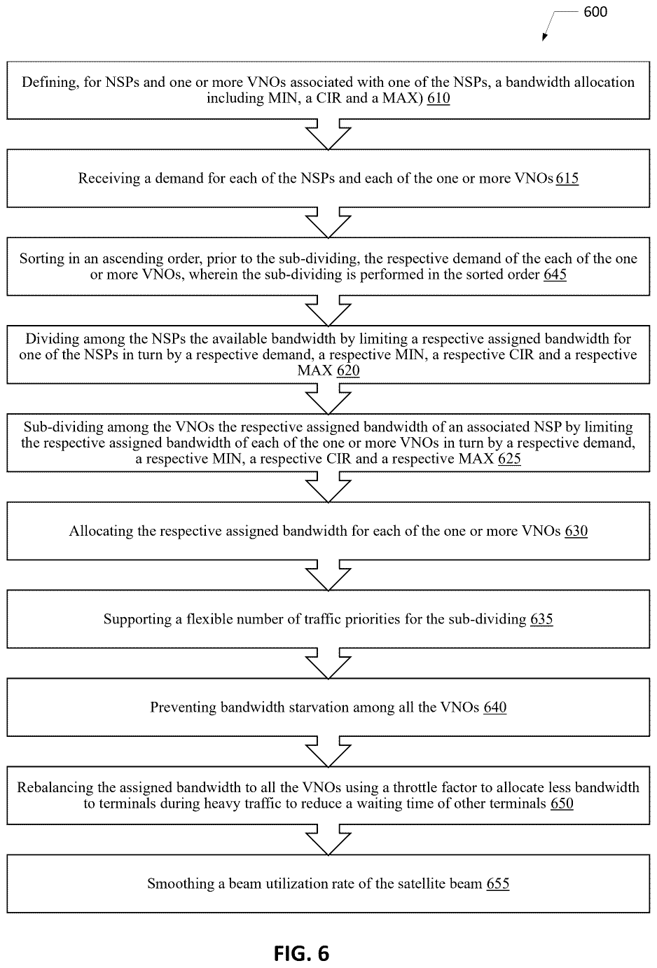

FIG. 6 is a flowchart of a method for distributing an available bandwidth of a satellite beam, according to various embodiments.

A method 600 for distributing an available bandwidth of a satellite beam to associated NSPs ensures, among other things, that each NSP and VNO receives a fair share of the available bandwidth based on their respective demands and predefined rates. The method 600 includes NP-VNOs, redirects leftover bandwidth to a default NSP/VNO (HSP/HNO), prevents starvation, and sets a bandwidth allocation timer.

Method 600 includes operation 610 for defining, for network service providers (NSPs) and one or more virtual network operators (VNOs) associated with one of the NSPs, a bandwidth allocation including a Minimum Information Rate (MIN), a Committed Information Rate (CIR) and a Maximum Information Rate (MAX). The bandwidth allocation parameters are defined to meet a VNO's MIN, transition between VNO's MIN and CIR, and transition between VNO's CIR and MAX. One of the NSPs is designated as a home NSP, and any leftover bandwidth of the available bandwidth is redirected to the home NSP. This redirection ensures that any unused bandwidth is efficiently utilized by the home NSP, preventing wastage and optimizing the overall bandwidth allocation. One of the VNOs associated with the home NSP is identified as a non-peak VNO, and the sub-dividing process redirects any leftover bandwidth of the available bandwidth to the non-peak VNO. This redirection ensures that the non-peak VNO can utilize the leftover bandwidth during non-peak times, further optimizing the overall bandwidth allocation.

Method 600 may include operation 615 for receiving a demand for each of the NSPs and each of the one or more VNOs. Predicating bandwidth allocation on demand ensures that the system can meet a VNO's MIN, transition between VNO's MIN and CIR, and transition between VNO's CIR and MAX, without wasting bandwidth on VNO's without demand.

Method 600 may include operation 620 for dividing among the NSPs the available bandwidth by limiting a respective assigned bandwidth for one of the NSPs in turn by a respective demand, a respective MIN, a respective CIR and a respective MAX. In certain embodiments, operation 620 includes dividing the available bandwidth based on weights associated with the NSPs. The weights are used to allocate the available bandwidth among the NSPs based on demand and predefined rates to ensure a fair distribution of bandwidth according to the weight of each NSP.

In different embodiments, operation 620 includes redirecting a leftover bandwidth to a home NSP. In certain embodiments, the home NSP is one of the NSPs that is designated to receive any remaining bandwidth after the initial allocation process. The action of redirecting a leftover bandwidth to the home NSP is to ensure efficient utilization of the available bandwidth and to prevent wastage. In certain embodiments, the redirection of leftover bandwidth to the home NSP is managed by the bandwidth allocator based on predefined parameters and real-time network conditions.

Method 600 may include operation 625 for sub-dividing among the VNOs the respective assigned bandwidth of an associated NSP by limiting the respective assigned bandwidth of each of the one or more VNOs in turn by a respective demand, a respective MIN, a respective CIR and a respective MAX. In certain embodiments, the sub-dividing of a leftover bandwidth of one of the NSPs is based on weights of the one or more VNOs associated with the one of the NSPs. In certain embodiments, sub-dividing comprises satisfying the CIR of all the VNOs prior to making a best effort to satisfy the MAX of all the VNOs if the respective available bandwidth of the associated NSP is greater than zero after satisfying the CIR.

In certain embodiments, one of the VNOs supports priorities. When priorities are supported, the demand received at operation 615 may include a demand per priority, and operation 625 sub-divides the respective assigned bandwidth across the priorities prior to the allocating. This considers the different priority levels of the traffic, ensuring that higher priority traffic is allocated bandwidth before lower priority traffic.

In different embodiments, operation 625 uses a default VNO (or HNO) that is associated with the HSP. The HNO may be a non-peak VNO for the redistribution of bandwidth that might otherwise go unused, and the sub-dividing redirects a leftover bandwidth of the available bandwidth to the HNO. This redirection of bandwidth helps in maintaining a balanced network load and prevents bandwidth wastage. The action of redirecting leftover bandwidth to the non-peak VNO is for multi-directional bandwidth distribution, which can be utilized on both Inroute and Outroute channels.

Method 600 may include operation 630 for allocating the respective assigned bandwidth for each of the one or more VNOs. In certain embodiments, the allocation further comprises allocating bandwidth to terminals associated with all of the VNOs having a non-zero demand. The bandwidth allocated to the terminals may be determined as a minimum of available slots, a service plan rate plus carryover, and a backlog per frame.

Method 600 may include operation 635 for supporting a flexible number of traffic priorities for the sub-dividing, for example, up to 8 priorities, and enables multi-level and multi-directional bandwidth distribution, usable on both Inroute and Outroute.

Method 600 may include operation 640 for preventing bandwidth starvation among all the VNOs. Method 600 may include operation 645 for sorting in an ascending order, prior to the sub-dividing, the respective demand of the each of the one or more VNOs, wherein the sub-dividing is performed in the sorted order. Method 600 may include operation 650 for rebalancing the assigned bandwidth to all the VNOs using a throttle factor to allocate less bandwidth to terminals during heavy traffic to reduce a waiting time of other terminals, wherein the throttle factor is based on bandwidth utilization and throughput utilization. In some embodiments, throttle factor may range between 0 and 1. This ensures that the network can handle high traffic scenarios efficiently while maintaining fair bandwidth distribution among all terminals.

Method 600 may include operation 655 for smoothing a beam utilization rate of the satellite beam, wherein the respective MIN, the respective CIR and the respective MAX are distinct for each of the one or more VNOs.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A computer-implemented method for distributing an available bandwidth of a satellite beam, the method comprising:
defining, for network service providers (NSPs) and one or more virtual network operators (VNOs) associated with one of the NSPs, a bandwidth allocation comprising a Minimum Information Rate (MIN), a Committed Information Rate (CIR) and a Maximum Information Rate (MAX);
receiving a demand for each of the NSPs and each of the one or more VNOs;
dividing among the NSPs the available bandwidth by limiting a respective assigned bandwidth for one of the NSPs in turn by a respective demand, a respective MIN, a respective CIR and a respective MAX;
sub-dividing among the VNOs the respective assigned bandwidth of an associated NSP by limiting the respective assigned bandwidth of each of the one or more VNOs in turn by a respective demand, a respective MIN, a respective CIR and a respective MAX; and
allocating the respective assigned bandwidth for each of the one or more VNOs,
wherein the respective MIN, the respective CIR and the respective MAX are distinct for each of the one or more VNOs.

2. The method of claim 1, wherein the available bandwidth is reduced by a beam MAX threshold associated with the satellite beam.

3. The method of claim 1, wherein one of the NSPs is a home NSP and redirecting a leftover bandwidth of the available bandwidth to the home NSP.

4. The method of claim 3, wherein one of the one or more VNOs associated with the home NSP is a non-peak VNO and the sub-dividing redirects a leftover bandwidth of the available bandwidth to the non-peak VNO.

5. The method of claim 1, wherein the dividing of the available bandwidth of the satellite beam is based on weights associated with the NSPs.

6. The method of claim 1, wherein dividing comprises satisfying the CIR of NSPs prior to making a best effort to satisfy the MAX of the NSPs if a leftover bandwidth of the satellite beam is greater than a beam threshold after satisfying the CIR.

7. The method of claim 1, wherein the sub-dividing of a leftover bandwidth of one of the NSPs is based on weights of the one or more VNOs associated with the one of the NSPs.

8. The method of claim 1, wherein sub-dividing comprises satisfying the CIR of all the VNOs prior to making a best effort to satisfy the MAX of all the VNOs if the respective available bandwidth of the associated NSP is greater than zero after satisfying the CIR.

9. The method of claim 1, wherein the allocating further comprises allocating bandwidth to terminals associated with all of the VNOs having a non-zero demand, wherein the bandwidth allocated to the terminals is determined as a minimum of available slots, a service plan rate plus carryover, and a backlog per frame.

10. The method of claim 1, wherein the satellite beam comprises an inroute.

11. The method of claim 1, wherein the satellite beam is serviced by a plurality of carrier rate organizers.

12. The method of claim 1, wherein one of the VNOs supports priorities, and the sub-dividing sub-divides the respective assigned bandwidth across the priorities prior to the allocating.

13. The method of claim 1, further comprising supporting a flexible number of traffic priorities for the sub-dividing.

14. The method of claim 1, further comprising preventing bandwidth starvation among all the VNOs.

15. The method of claim 1 further comprising sorting in an ascending order, prior to the sub-dividing, the respective demand of the each of the one or more VNOs, wherein the sub-dividing is performed in the sorted order.

16. The method of claim 1, further comprising rebalancing the assigned bandwidth to all the VNOs using a throttle factor to allocate less bandwidth to terminals during heavy traffic to reduce a waiting time of other terminals, wherein the throttle factor is based on bandwidth utilization and throughput utilization.

17. The method of claim 1, further comprising smoothing a beam utilization rate of the satellite beam.

18. A system to allocate an available bandwidth of a satellite beam, the system comprising a bandwidth allocator configured to:
define, for network service providers (NSPs) and one or more virtual network operators (VNOs) associated with one of the NSPs, a bandwidth allocation comprising a Minimum Information Rate (MIN), a Committed Information Rate (CIR) and a Maximum Information Rate (MAX);
receive a demand for each of the NSPs and each of the one or more VNOs;
divide among the NSPs the available bandwidth by limiting a respective assigned bandwidth for one of the NSPs in turn by a respective demand, a respective MIN, a respective CIR and a respective MAX;
sub-divide among the VNOs the respective assigned bandwidth of an associated NSP by limiting the respective assigned bandwidth of each of the one or more VNOs in turn by a respective demand, a respective MIN, a respective CIR and a respective MAX; and
allocate the respective assigned bandwidth for each of the one or more VNOs, wherein the respective MIN, the respective CIR and the respective MAX are distinct for each of the one or more VNOs.

19. The system of claim 18, wherein the bandwidth allocator sub-divides by satisfying the CIR of all the VNOs prior to making a best effort to satisfy the MAX of all the VNOs if the respective available bandwidth of the associated NSP is greater than zero after satisfying the CIR.

20. The system of claim 18, wherein the bandwidth allocator is further configured to rebalance the assigned bandwidth to all the VNOs using a throttle factor to allocate less bandwidth to terminals during heavy traffic to reduce a waiting time of other terminals, wherein the throttle factor is based on bandwidth utilization and throughput utilization.
